(19) United States
(12) Patent Application Publication
(10) Pub. No.: US 2004/0131517 A1
(43) Pub. Date: Jul. 8, 2004

(54) Material heat treatment system and method

(76) Inventor: Duncan E. Akporiaye, Arlington Heights, IL (US)

Correspondence Address: JOHN G TOLOMEI, PATENT DEPARTMENT, UOP LLC, 25 EAST ALGONQUIN ROAD, P O BOX 5017, DES PLAINES, IL, 60017-5017, US

(21) Appl. No.: 10/725,887

(22) Filed: Dec. 2, 2003

Related U.S. Application Data
(63) Continuation-in-part of application No. 10/337,070, filed on Jan. 3, 2003.

(51) Int. Cl. F28D 1/00; G05D 7/00; G05D 23/00

(52) U.S. Cl. 422/198; 422/109; 422/110

(57) ABSTRACT

A heat treatment system comprises a plurality of feed lines for feeding a fluid, a plurality of treatment zones, each treatment zone is fed by one of the plurality of feed lines, and includes at least one chamber for holding a material and flowing the fluid through the material, a plurality of heating elements, wherein each heating element heats the material in at least one of the plurality of chambers, and a plurality of detection or sampling devices. A method of treating a material comprises the steps of feeding a fluid to at least one treatment zone, wherein the treatment zone includes a plurality of chambers, holding treatment materials, controlling flow rate of the fluid to the treatment zone, flowing the fluid through the material in each chamber, heating the material in chambers, flowing the fluid out of the chambers and analyzing the fluid flowing out of the chambers.

### CROSS-REFERENCE TO RELATED APPLICATION

This application is a continuation in part of copending application Ser. No. 10/337,070 filed Jan. 3, 2003, the contents of which are hereby incorporated by reference.

### CROSS REFERENCE TO RELATED APPLICATION

This application is a continuation-in-part of our copending application U.S. application Ser. No. 10/337,070 filed Jan. 3, 2003, which is hereby incorporated by reference in its entirety.

### STATEMENT REGARDING FEDERALLY SPONSORED RESEARCH OR DEVELOPMENT

This invention was made under the support of the United States Government, Department of Commerce, National Institute of Standards and Technology (NIST), Advanced Technology Program, Cooperative Agreement Number 70NANB9H3035. The United States Government has certain rights in the invention.

### BACKGROUND OF THE INVENTION

1. Field of the Invention

The present invention is related to a system for the heat treatment of material, particularly for the simultaneous heat treatment of a plurality of materials. The present invention is also related to a method of heat treating material particularly for simultaneously heat treating a plurality of materials, such as catalysts.

2. Description of the Related Art

Before a material is selected for use in a commercial application, for example catalysts for hydrocarbon reactions in petroleum refining, a great number of materials may be examined for use in the envisioned application. A large number of material compositions may be synthesized, processed and screened while under consideration as candidates.

The traditional approach to the processing of new materials has been a sequential one. For example, one new potential material undergoes a treatment step in a vessel. Upon completion of the treatment, the current material is removed from the vessel and the next material is loaded. The treatment is repeated on the freshly loaded material. The process is repeated sequentially for each of the materials. This process is drawn out and labor intensive, introducing many chances for experimental error. Overall, processing of a plurality of new material formulations is a lengthy process at best.

Efforts have been made to expedite the processing of a plurality of materials is to place a small amount of each material into a corresponding number of small containers and then process each container. An example of a container and processing apparatus is disclosed in the commonly assigned patent application having Attorney Docket Number 103328, filed contemporaneously herewith, the disclosure of which is incorporated herein by reference.

Combinatorial chemistry has dealt mainly with the synthesis of new compounds. For example, U.S. Pat. Nos. 5,612,002 and 5,766,556 teach an apparatus and a method for simultaneous synthesis of multiple compounds. Akporiaye, D. E.; Dahl, I. M.; Karlsson, A.; Wendelbo, R. Angew Chem. Int. Ed. 1998, 37, 9-611 disclose a combinatorial approach to the hydrothermal synthesis of zeolites, see also WO 98/36826.

Combinatorial approaches have also recently been used for the evaluation and screening of catalysts; see for example commonly assigned U.S. Pat. Nos. 6,342,185 and 6,368,865, U.S. Patent Application Publications 2003/0173205 A1 and 2003/0175173 A1 and U.S. patent application Ser. No. 10/095,395.

Many of the same concerns apply to the design of a combinatorial treatment array as to the combinatorial screening and evaluation arrays described in the above patents or applications. For example, it is important that the treatment fluids be fed to each reactor in a known and controlled amount. It is also important to be able to control and select the composition of the treatment fluid flowing through each of the reactors. Another important feature of a combinatorial treatment array is the ability to provide multiple and simultaneous treatment conditions to each of the reactors in an array so that each material being treated can undergo a different treatment condition.

What is needed is a material heat treatment system for the simultaneous heat treatment of a plurality of materials that addresses the above concerns.

### BRIEF SUMMARY OF THE INVENTION

In accordance with the present invention, an improved heat treatment system is provided for the treatment of materials. The inventive system includes a plurality of feed lines for feeding a fluid, a plurality of treatment zones, each fed by one of the plurality of feed lines, wherein each treatment zone includes at least one chamber for holding a material and flowing the fluid through the material, a plurality of heating elements, wherein each heating element heats the material in one of the plurality of chambers, and one or more detectors able to measure a property of the effluents of the chambers.

Also in accordance with the present invention, an improved method of treating material is provided. The inventive method includes the steps of feeding a fluid to at least one treatment zone, wherein the treatment zone includes a plurality of chambers, each chamber holding a material to be treated, controlling flow rate of the fluid to the treatment zone, flowing the fluid through the material in each chamber, independently heating the material in the chambers, flowing the fluid out of the chambers, and measuring at least one property of each of the effluents.

Also in accordance with the present invention, another embodiment of the improved method is provided for treating material. The inventive method includes the steps of feeding a fluid to a plurality of treatment zones, wherein each treatment zone includes at least one chamber with each chamber holding a material to be treated, controlling flow rate of the fluid to each chamber, flowing the fluid through the material in each chamber, independently heating the material in the chambers, controlling temperature in each chamber, flowing the fluid out of the chambers, and measuring at least one property of each of the effluents.

The improved heat treatment system and method allow a plurality of materials to be treated simultaneously under the same or different treatment conditions, greatly reducing the time required to treat several materials.

These and other objects, features and advantages are evident from the following description of an embodiment of the present invention, with reference to the accompanying drawings.

### BRIEF DESCRIPTION OF THE SEVERAL VIEWS OF THE DRAWINGS

FIG. 1 is a process flow diagram of the heat treatment system.

FIG. 2 is a side sectional view of a preferred treatment zone of the heat treatment system.

### DETAILED DESCRIPTION OF THE INVENTION

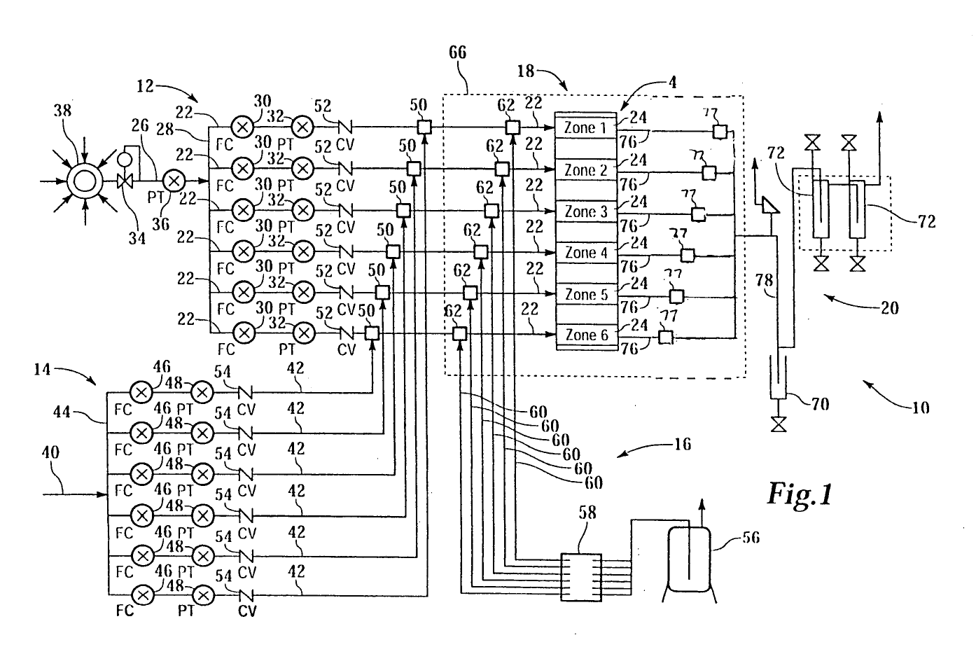

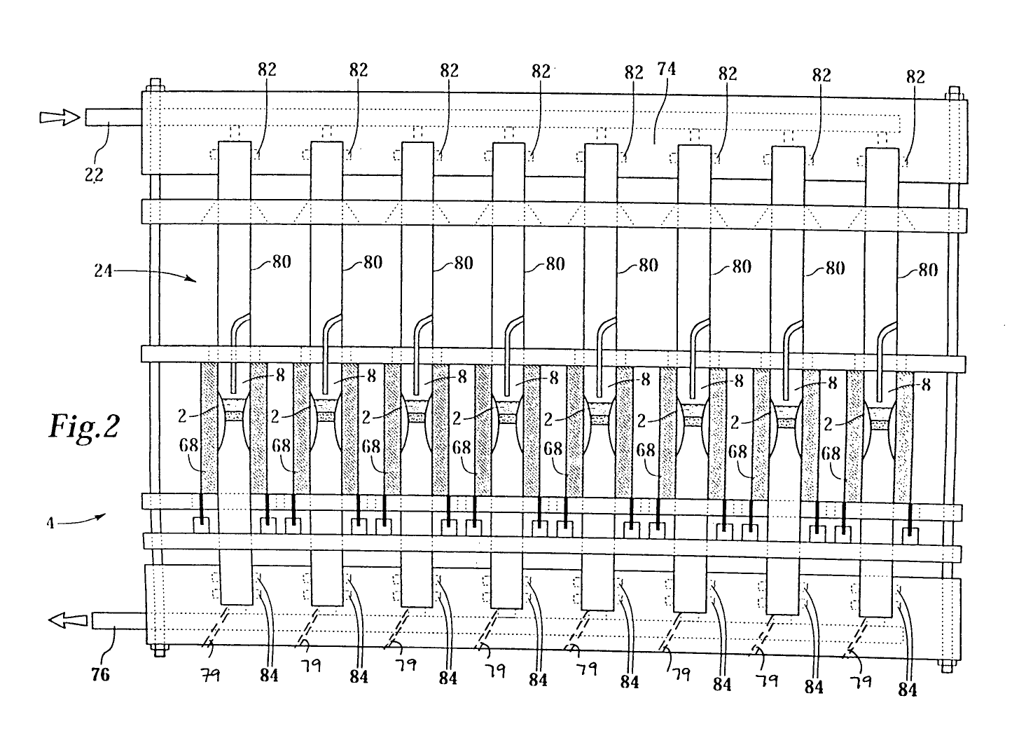

A novel and improved material heat treatment system 10 is shown and its method of use is described in conjunction with FIGS. 1 and 2. Heat treatment system 10 allows a plurality of materials 2 to be simultaneously treated in parallel within a multi-chamber treatment assembly 4. System 10 allows various mixtures of fluids to be used for the treatment of materials 2, and in a preferred embodiment allows the possibility of mixing separate gas sources with a liquid source. Alternatively, heat treatment system 10 allows for various differing fluids to undergo treatment through contact with a plurality of materials such as catalysts or adsorbents.

Heat treatment system 10 can provide for fluid contacting of several samples of the same material 2 under a variety of treatment conditions, or heat treatment system 10 can provide for contacting a plurality of different materials 2 under the same treatment conditions. Heat treatment system 10 is versatile in this respect, because it accommodates several different treatment situations for either one material 2 or for a plurality of materials 2.

Preferred materials 2 that can be contained within heat treatment system 10 include inorganic catalysts, such as metallic catalysts used in the petrochemical industry, metals, and other inorganic materials, such as adsorbents, which undergo one or more treatment steps before the material has certain desired properties. Preferably, a material 2 to be used in heat treatment system 10 is in particulate form, such as a fine powder having a small particle size, so that treatment of material 2 can be essentially uniform throughout an entire sample of material 2.

Examples of processes that may be conducted using the present invention include a wide variety of hydrocarbon conversion processes such as cracking, hydrocracking, alkylation of both aromatics and isoparaffins, isomerization, polymerization, reforming, dewaxing, hydrogenation, dehydrogenation, transalkylation, dealkylation, hydration, dehydration, hydrotreating, hydrodenitrogenation, hydrodesulfurization, methanation, ring opening, and syngas shift processes. Specific examples are discussed in H. Pines, The Chemistry Of Catalytic Hydrocarbon Conversions, Academic Press (1981). The catalysts contained within the heat treatment system may be those catalysts effective in the above listed processes. In addition, absorption processes may be conducted in the heat treatment system through contacting at least potential adsorbates with one or more adsorbates, or any other processes involving passing a fluid over a material under controlled temperature conditions.

Heat treatment system 10 can be used to simultaneously evaluate a plurality of materials 2 in parallel using various mixtures of fluids. The treatment fluid flows through chambers 8 at a high enough flow rate so that it pushes any moisture around material 2 through chamber 8. The treatment fluid also flows uniformly through chamber 8 and around material 2 to ensure homogenous treatment of material 2.

In a preferred embodiment of the present invention, system 10 has the possibility of mixing separate gas sources with a liquid source. Heat treatment system 10 can perform various types of treatment, some examples being a reduction treatment using hydrogen gas (H₂), an oxidation treatment with a mixture of nitrogen gas (N₂) and air, or a steaming treatment with a mixture of nitrogen gas, air and water vapor (H₂O). Examples of gases being fed to system 10 are pure components, such as pure hydrogen gas or oxygen gas, or mixtures of gases, such as half nitrogen gas and half air. Examples of treatment liquids that may be used in system 10 are pure water or hydrochloric acid (aqueous HCl). In addition to treating the solid material, the term treatment may also refer to treating a fluid through contact with a material such as a catalyst or adsorbent. For example the treatment fluid may be a reactant or mixture of reactants which undergo a reaction when contacted with material 2. The fluid is treated through contact with the material 2 and an effluent is generated which is then analyzed.

Treatment system 10 can be operated with fluid flow rates through each chamber 8 of between about 0.1 cm³/min to about 250 cm³/min, preferably between about 2.5 cm³/min and about 25 cm³/min. Materials 2 can also be heated, as described below, to temperatures between room temperature (about 20° C.), to high temperatures of about 1000° C., and preferably between about 300° C. and about 800° C. Other process conditions that can be altered in treatment system 10 include materials 2 being processed, and treatment fluids used to treat materials 2. The reactant fluid may be flowed to the treatment zone in pulses within a stream of inert fluid.

Turning to FIG. 1, one embodiment of heat treatment system 10 includes three feed sections, including a treatment fluid feed section 12, a diluent fluid feed section 14, and a liquid feed section 16, as well as a treatment section 18 and a recovery section 20. Each feed section provides a means to feed a particular component, or mixture of components, treatment section 18 via process lines 22. Treatment section 18 includes multi-chamber treatment assembly 4, which includes a plurality of treatment zones 24 for containing the plurality of materials 2 for treatment. Treatment section 18 also includes detection devices 77 for measuring a property in the effluent of each the treatment zones 24. It is also envisioned that sampling devices such as the slip streams 79 of FIG. 2 may be used in addition to or in place of the detection devices. The slip streams 79 are located upstream of effluent conduit 76 which carries the combined effluents from multiple chambers. Portions of the effluent may be sampled for analysis using the sampling devices. Recovery section 20 includes a knock-out pot 70 and a set of gas scrubbers 72 to recover components from the effluent of treatment section 18.

Heat treatment system 10 is designed so that several variables can be selected or controlled, allowing treatment system 10 to simultaneously perform a plurality of treatments on a plurality of materials 2. Variables that can be selected or controlled include: materials 2 to be treated in each chamber 8; treatment fluid that will flow through the materials 2 in each chamber 8, including which fluids, such as H₂ and other gases, H₂O and other liquids, or mixtures of gases and liquids, and the compositions of the fluids; treatment fluid flow rates; flow patterns of the treatment fluid in the plurality of chambers 8; and temperatures of the material 2 in each chamber 8 during treatment, wherein the temperature of one treatment zone is independent of other treatment zones and may be individually controlled for each treatment zone and can be a constant predetermined temperature or a predetermined temperature profile controlled by a heating element.

Continuing with FIG. 1, treatment feed section 12 feeds a treatment fluid to system 10. The treatment fluid can be a pure component, such as pure H₂ gas or pure H₂O, or a single hydrocarbon, or it can be a mixture of fluids, such as a mixture of N₂ gas and air and mixtures of hydrocarbons.

Treatment feed section 12 may include a treatment fluid manifold (not shown) which supplies the treatment fluid to a treatment feed line 26, which feeds into a treatment flow splitter 28 for splitting the flow of the treatment fluid into a plurality of process lines 22. Preferably, each process line 22 includes a treatment control valve 30 so that a predetermined flow rate of the treatment fluid in each process line 22 can be achieved. Treatment control valves 30 allow the flow rate in each process line to be controlled so that the flow rate could be equal in each process line 22, or so that different process lines 22 can have different flow rates, depending on the desired application. In one embodiment, each treatment control valve 30 is controlled by a process line pressure transmitter 32 in each process line 22 downstream of treatment control valve 30.

In one embodiment, treatment feed section 12 includes a pressure control valve 34 upstream of treatment flow splitter 28, where a pressure transmitter 36 controls pressure control valve 34. Pressure control valve 34 maintains a predetermined pressure upstream of treatment flow splitter 28 to ensure proper gas pressure and flow of the treatment fluid through process lines 22.

In a preferred embodiment, shown in FIG. 1, treatment feed section 12 includes a multi-port selection valve 38 upstream of treatment flow splitter 28. Multi-port selection valve 38 selectively feeds a plurality of treatment fluids from several treatment feed manifolds (not shown) to treatment feed line 26. Multi-port selection valve 38 can comprise any known multiple input valve or any system that selects a single fluid output from multiple fluid inputs, such as a valve and manifold arrangement.

Diluent fluid feed section 14 allows feeding of a diluent fluid to each of the process lines 22 in system 10. If desired, a diluent fluid feed manifold (not shown) may feed diluent feed line 40 that diluent flow splitter 44 splits into a plurality of diluent lines 42. Preferably, the flow rate in each diluent line 42 is controlled by a diluent control valve 46 downstream of diluent flow splitter 44. A downstream diluent line pressure transmitter can control each control valve 46. Although neither a multi-port selection valve nor a pressure control valve is shown in diluent feed line 40, either could be included.

Upstream of treatment section 18 each diluent line 42 connects to one of the plurality of process lines 22 at a plurality of diluent mixing zones 50. In an alternate embodiment, each diluent line 42 may simply join a corresponding process line 22 so that the process and diluent fluids mix freely. However, any mixing methods could be used at each diluent mixing zone 50, such as a mixer or other means to mix two fluids together.

Preferably each process line 22 includes a process line check valve 52 upstream of mixing zone 50, and each diluent line 42 includes a diluent line check valve 54 upstream of mixing zone 50. Check valves 52, 54 prevent back mixing of fluids into process lines 22 and diluent lines 42.

Liquid feed section 16 provides a means of feeding a treatment liquid to system 10. Although for many applications it is undesirable to treat materials 2 with a component in its liquid phase, in some cases it is desirable to use a component that is in the liquid phase at room temperature, such as water (H₂O) or hydrochloric acid (HCl). Therefore, it is advantageous for system 10 to accommodate liquid feed addition. Liquid feed section 16 includes a means for feeding a treatment liquid, such as a feed reservoir 56, a liquid injection pump 58, a plurality of liquid lines 60, and a mixing means 62 for mixing the liquid in liquid lines 60 with the treatment fluid in process lines 22.

Feed reservoir 56 is an optional storage tank for the treatment liquid so that the treatment liquid may be kept near system 10. Liquid pump 58 draws liquid out of feed reservoir 56 and pumps the treatment liquid through the plurality of liquid lines 60. FIG. 1, shows the preferred us of a multi-channel liquid injection pump 58 to deliver the treatment liquid to liquid lines 60. Multi-channel liquid injection pump 58 allows control of the flow in each liquid line 60 by changing the number of channels in injection pump 58 that supply each liquid line 60. An example of a suitable multi-channel pump is the Model # 78001-10 pump manufactured by Ismatec. As an alternative individual pumps (not shown) may supply each liquid line 60 to individually control the liquid flow rate within each liquid line 60.

Downstream of liquid pump 58 a mixing means 62 connects each liquid line 60 and a corresponding process line 22 and mixes the treatment fluid and diluent fluid mixture in each process line 22. Mixing means 62 may include any type of mixing device and may include a heating element (not shown) to provide additional energy for vaporization of any treatment liquid. Mixing means 62 may simply comprise a section of line but preferably is a vortex mixer. The formation of a vortex aids the vaporization of the treatment liquid within process lines 22.

Preferably, mixing means 62 is placed within a heated enclosure 66 so that the treatment liquid is vaporized before entering multi-chamber treatment assembly 4 to ensure that all treatment fluids, including the treatment fluid and diluent fluid, remain in the gas phase as they pass through multi-chamber treatment assembly 4. A separate heated enclosure 66 could solely vaporize the liquid feed or it could also heat multi-chamber treatment assembly 4, as discussed below and shown in FIG. 1. After mixing, a treatment mixture of the combined treatment fluid, diluent fluid and any vaporized treatment liquid enter treatment zone 24.

Treatment section 18 includes heated enclosure 66 and a multi-chamber treatment assembly 4 for treating with the plurality of materials 2 during the operation of system 10. Treatment section 18 also includes detection devices 77 to analyze the effluents of the treatment zones 24 or sampling devices 79 for remote or offline analysis of the effluents.

As described in the depicted embodiment, heated enclosure 66 provides thermal energy to vaporize the treatment liquid and also provides energy for heat treatment of materials 2. FIG. 1, shows heated enclosure 66 surrounding multi-chamber treatment assembly 4, the plurality of mixing means 62, and the detection devices 77. Depending upon the application, is may not be necessary that the detection devices 77 be located within heated enclosure 66, and the detection devices 77 may be located outside of the heated enclosure. Similarly, sampling devices may be located internal to or external to heated enclosure 66. In an alternative embodiment, each chamber 8 of multi-chamber treatment assembly 4 may also have its own heating element 68, see FIG. 2, in order to independently control the temperature of each chamber 8. Independent temperature control allows heating of each chamber 8 to a different temperature or temperature profile to individually compensate each chamber 8 for increases or decreases in temperature due to local heating or cooling affects such as a heat of reaction between the treatment mixture and material 2. However, one having ordinary skill in the art would recognize that heat zones or an isothermal oven could be used in place of heated enclosure 66 or heating elements 68.

Multi-chamber treatment assembly 4 provides a means to enclose the plurality of materials 2 in separate chambers 8 for the individual, simultaneous, controlled and parallel treatment with each of the plurality of materials 2. Multi-chamber treatment assembly 4 includes a plurality of treatment zones 24, as is shown in FIG. 1, for performing a particular treatment step. Each treatment zone 24 includes one or more chambers 8, see FIG. 2, wherein vessels such as tubes 80 enclose each chamber 8 and the material 2 to be treated. The treatment mixture flows into each treatment zone 24 and through a chamber or a plurality of chambers 8, and along with the heat provided by heated enclosure 66 and heating elements 68, and is treated by contact with each of the plurality of materials 2.

Alternative embodiments of multi-chamber treatment assembly 4 may be employed without varying from the scope of the present invention. As shown in FIG. 2, each chamber 8 is preferably sealed to isolate each material 2 from its surroundings, for example by seals 82, 84 shown in FIG. 2, and to feed each chamber 8 with its intended flow rate of treatment fluid. In some applications it may be desirable that each chamber 8 be fed with an equal flow rate of the treatment mixture, while in others it may be desirable that individual chambers 8, or banks of chambers 8, be fed with different flow rates of the treatment mixture.

FIGS. 1 and 2, show the treatment fluid split into a total of six process lines 22, diluted by mixing with diluent fluid from six diluent lines 42 and then mixed with the treatment liquid from six liquid lines 60. Each of the six process lines 22 feed into one of six treatment zones 24, wherein each treatment zone 24 includes eight individual chambers 8, as in FIG. 2, for a total capacity of forty-eight chambers 8 in multi-chamber treatment assembly 4. This and other embodiments are described in detail in the commonly assigned, co-pending application U.S.application Ser. No. 10/337,040, the disclosure of which is incorporated herein by reference in its entirety.

After treating with materials 2 in multi-chamber treatment assembly 4, the treatment mixture forms an effluent fluid. The effluent fluid from each treatment zone 24 flows into an effluent conduit 76, shown in FIG. 1. Each effluent conduit is equipped with detection device 77 or a sampling device 79 as shown in FIGS. 1 and 2 respectively. After detection or sampling, the plurality of effluent conduits 76 are combined into a common effluent line 78, see FIG. 1, which feeds recovery section 20. Detection devices may be probes or sensors placed within the effluent or a slip stream of the effluent or a sampling device such as a valve or a slip stream may be used to conduct a portion of the effluent to an analytical device that may be remote or offline. Also, the sampling device may function to store a portion of the effluent until it is analyzed. Analytical devices may be those commonly used with reactors such as chromatographs, gas or liquid, fluorescence detectors mass spectrometers, spectrometers such as infrared, ultraviolet and the like, pulse charge detectors, thermal conductivity devices, and probe chemical indicator reaction, e.g., passing a gas over a chemical indicator which is either in a liquid or solid phase. Generally, the detection device can be any sensor or analytical device that can detect or monitor changes in a property, such as a chemical or physical property, of the effluent stream or slip stream containing the effluent.

The effluent fluid may contain components that are undesirable for venting into the atmosphere such as acidic components that can corrode or valuable components suitable for reuse or sale In an example where the effluent fluid is a gas, recovery section 20 may include a knock-out pot 70 to condense condensable effluent components and a series of scrubbers 72 to reclaim any components such as acidic or basic components remaining in the effluent.

Knock-out pot 70 may be placed downstream of multi-chamber treatment assembly 4 so that condensable components, such as water vapor, will be “knocked out” of the effluent. Knocking-out condensable components can be achieved in several ways, all of which are well known in the art. One embodiment includes a tube flowing through a cold water bath, so that the condensables form on the walls of the tube and run down away from knock-out pot 70.

Optional gas scrubbers 72 are placed downstream of knock-out pot 70 to reclaim components by scrubbing them out of the remaining effluent. A typical scrubber uses a scrubbing fluid, usually water or some other liquid capable of dissolving the components, and countercurrently contacting the scrubbing fluid and the effluent gas in a column over packing. Effluent gas contact with scrubbing liquid dissolves components from the gas and typically continues up the column until a negligible amount of the components remain in the effluent gas. Various suitable gas scrubbers are well known in the art and available for use in the present invention. After the components have been scrubbed, the remaining effluent gas is vented to the atmosphere.

One having ordinary skill in the art would recognize that other recovery means could be employed to recover components from the effluent fluid. For example, the recovery section can include unit operations such as distillation columns, absorption and adsorption columns, chromatography columns or any other equipment capable of recovering components from the effluent fluid.

Each piece of equipment in heat treatment system 10 can be constructed out of a wide variety of materials. The material of construction for each individual piece of equipment should be chosen based on the process conditions expected for that equipment, such as corrosion due to the chemical components that will come in contact with the equipment, temperature, and pressure. Examples of suitable materials of construction include metals and their alloys, low grade steel, stainless steels, super-alloys like Incolloy, Inconel and Hastelloy, engineering plastics, such as VITON™ and TEFLON™, and high temperature plastics, ceramics such as silicon carbide and silicon nitride, glass, and quartz.

Treatment system 10 can provide for one or more treatment conditions and can simultaneously provide for the treatment by one or more materials 2.

A treatment condition is defined as a distinct treatment fluid composition, treatment fluid flow rate, temperature profile and any other variable which can be altered to affect the treatment of material 2. For example, if a material 2 is contacted with a treatment fluid having a first composition and a first flow rate and under a first temperature profile, this is considered a first treatment condition. A second treatment condition is defined by contacting the same material 2 with a second treatment fluid with the first flow rate and under the same first temperature profile. A third treatment condition is implemented if the same material 2 is contacted with the first treatment fluid at a second flow rate under the first temperature profile. Similarly, a forth treatment condition occurs if the material 2 is contacted with the first treatment fluid having the first fluid flow rate but under a second temperature profile.

The heating elements of multi-chamber treatment assembly 4 allows for individual temperature control of each of the plurality of chambers 8 so that each chamber 8 may have a unique temperature profile or banks of profiles. For example, heating elements 68 can be set so that a bank includes from one to all of the chambers 8 in a particular temperature zone. Treatment system 10 can be designed to accommodate several permutations of treatment fluid compositions and flow rates. For discussion purposes, a fluid flow is defined as a particular treatment fluid composition and flow rate and a temperature zone is defined as one or more chambers 8 that undergo a particular temperature profile.

In one arrangement, treatment system 10 is designed so that each process line 22 feeds into a separate chamber 8 so that there is one inlet line for each chamber 8. This arrangement allows for a different treatment fluid flow through each chamber 8. The heating elements can control the temperatures in each chamber 8 of this arrangement so that the temperature in each chamber 8 is the same, resulting in a common temperature zone for all chambers 8 in treatment system 10, or the heating elements can control the temperature profile in each chamber 8 so that there is a different temperature zone for each chamber 8, or for a bank of chambers 8.

In another embodiment, the treatment fluid can be fed to treatment system 10 from a common feed line so that each chamber 8 has the same fluid flow and composition. The heating elements can be controlled so each that chamber 8 is in a different temperature zone, or so that there are banks of temperature zones, with each temperature zone corresponding to one or more chambers 8.

In yet another embodiment, shown in FIGS. 1 and 2 and described above, each process line 22 feeds into a treatment zone 24, wherein each treatment zone 24 includes a plurality of chambers 8 arranged in rows that are generally linear. This embodiment allows a different composition and flow rate of the treatment fluid to be fed to each treatment zone 24 so that each row of chambers 8 associated with a particular treatment zone 24 has the same treatment fluid flow. In a preferred embodiment there are a total of six treatment zones 24, as shown in FIG. 1, so that there can be a total of six treatment fluid flows, and wherein each treatment zone 24 includes eight chambers 8, as shown in FIG. 2. This arrangement results in a total of forty-eight chambers 8 defining six rows substantially perpendicular to eight columns of chambers 8 with each column containing a different chamber 8 from each row.

The heating elements can be controlled so that there is a different temperature zone along the plurality of columns of chambers 8, wherein each column is generally perpendicular to the rows of chambers 8. In a preferred embodiment a total of six rows, allowing for six fluid flows, and eight columns, allowing for eight different temperature zones, are present, allowing for a total of forty-eight chambers 8. The six treatment fluid flows described above are arranged perpendicular to the eight columns so that each chamber 8 in a column can have a different fluid flow than every other chamber 8 in that column. With individual temperature variation over each chamber 8 in a row this arrangement allows for 48 different treatment conditions in the same apparatus. It is also possibly through the use of restrictors or other flow control means to vary the fluid flow from each line 22 into individual chambers within a column.

The method used by heat treatment system 10 to treat fluids using plurality of materials 2 includes the steps of feeding a fluid to at least one treatment zone 24, wherein the treatment zone 24 includes a plurality of chambers 8 with each chamber 8 holding a material 2 to be treated, controlling the flow rate of the fluid to the treatment zone 24, flowing the fluid through material 2 in each chamber 8, heating the material 2 in at least one chamber 8, flowing the fluid out of chambers 8, and determining a property of the fluid exiting the chambers 8. The fluid exiting the chambers may be directly analyzed according to commonly used sensing and analytical techniques. For example, the direct analysis may be used to determine a chemical or physical property of the effluent. Indirect techniques may be employed instead of or addition to the direct techniques. Examples of indirect techniques include monitoring the release of a component from the material into the treatment fluid, monitoring the take up of a component from the treatment fluid into the material, or monitoring the change of the physical properties of the fluid due to a change in the material. Furthermore, in situ monitoring may be employed.

In a another embodiment, the method includes the steps of feeding a plurality of fluids to treatment system 10, selecting one of the plurality of fluids with multi-port selection valve 38, and feeding the selected fluid to treatment zones 24, diluting the fluid before feeding the fluid to treatment zones 24, mixing a liquid with the fluid before feeding the fluid to treatment zones 24, vaporizing the liquid before feeding the fluid to treatment zones 24, heating each chamber 8 independently of the rest of the plurality of chambers 8, analyzing the fluid exiting chambers 8, knocking out condensable components from the fluid with knock-out pot 70 after flowing the fluid out of chambers 8, scrubbing the fluid with scrubbers 72 to reclaim components after flowing the fluid out of chambers 8

The heat treatment system of the present invention provides a versatile system that can use multiple gas sources and a liquid source to simultaneously treat a plurality of catalysts in parallel. This versatility allows use of the heat treatment system for a variety of treatment situations, such as a reduction treatment, an oxidation treatment and a steaming treatment. The heat treatment system also allows for the simultaneous treatment of a large number of catalysts, speeding up the already lengthy process of catalyst preparation and testing. Furthermore, with the sampling and detection devices, the heat treatment system may be used to evaluate catalysts and adsorbents.

The method and apparatus of the present invention are exemplified in the following examples.

### EXAMPLE 1

A sample of about 5 grams of ZSM-5 catalyst is measured and loaded into each of forty-eight chambers and each chamber is inserted into a selected column and row of the treatment apparatus.

Six different fluids are fed to the treatment apparatus; wet chlorine gas (HCl/H₂O), pure vaporized water (H₂O), wet N₂ gas, a 50/50 mixture of Air and N₂ gas (O₂/N₂), pure N₂ gas, and a mixture of 75% water and 25% air (H₂O/Air). Each fluid is fed to one of six rows columns of the treatment apparatus at one of six different flow rates; 2.5 cm^{3/}min, 5 cm³/min, 7.5 cm³/min, 10 cm³/min, 15 cm³/min, and 25 cm³/min. The flow rates are varied by control valves or by restriction orifices designed to provide the desired flow rate through each chamber. Therefore there are a total of forty-eight different flows fed to the treatment apparatus corresponding to each combination of the 6 fluids and the 6 flow rates, wherein each of the 48 flows is fed to one of the 48 chambers.

The 48 flows are fed to the chambers while heating elements heat each of the 48 chambers to a temperature of 300° C. The catalyst in each chamber is maintained at this temperature for a total of 2 hours and then each chamber is allowed to cool slowly until the materials have reached room temperature.

Each of the 48 material samples are then removed either for further processing, or for screening to determine which of the samples is most effective for a selected application.

The flow and temperature that a particular sample of material encounters is shown in the following table:

| Cartridge # | Material | Fluid | Flow Rate | | Temperature |
|---|---|---|---|---|---|
| 1 | ZSM-5 | HCl/H₂O | 2.5 | cm³/min | 300° C. |
| 2 | ZSM-5 | HCl/H₂O | 2.5 | cm³/min | 300° C. |
| 3 | ZSM-5 | HCl/H₂O | 2.5 | cm³/min | 300° C. |
| 4 | ZSM-5 | HCl/H₂O | 2.5 | cm³/min | 300° C. |
| 5 | ZSM-5 | HCl/H₂O | 2.5 | cm³/min | 300° C. |
| 6 | ZSM-5 | HCl/H₂O | 2.5 | cm³/min | 300° C. |
| 7 | ZSM-5 | HCl/H₂O | 2.5 | cm³/min | 300° C. |
| 8 | ZSM-5 | HCl/H₂O | 2.5 | cm³/min | 300° C. |
| 9 | ZSM-5 | H₂O | 5 | cm³/min | 300° C. |
| 10 | ZSM-5 | H₂O | 5 | cm³/min | 300° C. |
| 11 | ZSM-5 | H₂O | 5 | cm³/min | 300° C. |
| 12 | ZSM-5 | H₂O | 5 | cm³/min | 300° C. |
| 13 | ZSM-5 | H₂O | 5 | cm³/min | 300° C. |
| 14 | ZSM-5 | H₂O | 5 | cm³/min | 300° C. |
| 15 | ZSM-5 | H₂O | 5 | cm³/min | 300° C. |
| 16 | ZSM-5 | H₂O | 5 | cm³/min | 300° C. |
| 17 | ZSM-5 | H₂O/N₂ | 7.5 | cm³/min | 300° C. |
| 18 | ZSM-5 | H₂O/N₂ | 7.5 | cm³/min | 300° C. |
| 19 | ZSM-5 | H₂O/N₂ | 7.5 | cm³/min | 300° C. |
| 20 | ZSM-5 | H₂O/N₂ | 7.5 | cm³/min | 300° C. |
| 21 | ZSM-5 | H₂O/N₂ | 7.5 | cm³/min | 300° C. |
| 22 | ZSM-5 | H₂O/N₂ | 7.5 | cm³/min | 300° C. |
| 23 | ZSM-5 | H₂O/N₂ | 7.5 | cm³/min | 300° C. |
| 24 | ZSM-5 | H₂O/N₂ | 7.5 | cm³/min | 300° C. |
| 25 | ZSM-5 | Air/N₂ | 10 | cm³/min | 300° C. |
| 26 | ZSM-5 | Air/N₂ | 10 | cm³/min | 300° C. |
| 27 | ZSM-5 | Air/N₂ | 10 | cm³/min | 300° C. |
| 28 | ZSM-5 | Air/N₂ | 10 | cm³/min | 300° C. |
| 29 | ZSM-5 | Air/N₂ | 10 | cm³/min | 300° C. |
| 30 | ZSM-5 | Air/N₂ | 10 | cm³/min | 300° C. |
| 31 | ZSM-5 | Air/N₂ | 10 | cm³/min | 300° C. |
| 32 | ZSM-5 | Air/N₂ | 10 | cm³/min | 300° C. |
| 33 | ZSM-5 | N₂ | 15 | cm³/min | 300° C. |
| 34 | ZSM-5 | N₂ | 15 | cm³/min | 300° C. |
| 35 | ZSM-5 | N₂ | 15 | cm³/min | 300° C. |
| 36 | ZSM-5 | N₂ | 15 | cm³/min | 300° C. |
| 37 | ZSM-5 | N₂ | 15 | cm³/min | 300° C. |
| 38 | ZSM-5 | N₂ | 15 | cm³/min | 300° C. |
| 39 | ZSM-5 | N₂ | 15 | cm³/min | 300° C. |
| 40 | ZSM-5 | N₂ | 15 | cm³/min | 300° C. |
| 41 | ZSM-5 | H₂O/Air | 25 | cm³/min | 300° C. |
| 42 | ZSM-5 | H₂O/Air | 25 | cm³/min | 300° C. |
| 43 | ZSM-5 | H₂O/Air | 25 | cm³/min | 300° C. |
| 44 | ZSM-5 | H₂O/Air | 25 | cm³/min | 300° C. |
| 45 | ZSM-5 | H₂O/Air | 25 | cm³/min | 300° C. |
| 46 | ZSM-5 | H₂O/Air | 25 | cm³/min | 300° C. |
| 47 | ZSM-5 | H₂O/Air | 25 | cm³/min | 300° C. |
| 48 | ZSM-5 | H₂O/Air | 25 | cm³/min | 300° C. |

### EXAMPLE 2

A sample of about 2 grams of ZSM-11 catalyst is loaded into each chamber of 48 reactor wells and each reactor well is inserted into a particular column and row of the treatment apparatus.

H₂ gas is fed to the treatment apparatus in six different feed lines, wherein each feed line supplies H₂ to one of six treatment zones, with each treatment zone including eight chambers. The chambers associated with a particular treatment zone are all located in the same row so that there are a total of six rows, with each row having eight chambers per row.

The six feed lines feed the H₂ gas at different flow rates so that each chamber in the first treatment zone sees a flow rate of about 2.5 cm³/min, each chamber in the second treatment zone sees a flow rate of about 5 cm³/min, each chamber in the third treatment zone sees a flow rate of about 10 cm³/min, each chamber in the fourth treatment zone sees a flow rate of about 15 cm³/min, each chamber in the fifth treatment zone sees a flow rate of about 20 cm³/min, and each chamber in the sixth treatment zone sees a flow rate of about 25 cm³/min.

Each chamber has an associated heating element to heat the material in the chamber to a predetermined temperature, and the heating elements in each column of chambers are set so that each column of chambers is heated to a different temperature. There are a total of 8 columns, wherein the columns are perpendicular to the rows described above, and wherein each column includes 6 chambers. The chambers in the first column are left unheated so that they are at room temperature, about 20° C., the chambers in the second column are heated to a temperature of about 100° C., the chambers in the third column are heated to a temperature of about 150° C., the chambers in the fourth column are heated to a temperature of about 200° C., the chambers of the fifth column are heated to about 250° C., the chambers of the sixth column are heated to about 300° C., the chambers of the seventh column are heated to about 350° C., and the chambers of the eighth column are heated to about 400° C.

The flow of H₂ gas is kept constant for about 1.5 hours and the temperatures of the chambers are maintained at the temperatures given above by the heating elements full 1.5 hours. After 1.5 hours the flow of H₂ is stopped, the heating elements are off and the reactor wells and materials are allowed to cool until they are at room ture. Each of the forty-eight material samples are then removed either for further ing, or for screening to determine which of the samples is most effective for a application.

The flow and temperature that a particular sample of material encounters is shown in the following table:

| Cartridge | | Col- | | | | Tem- |
|---|---|---|---|---|---|---|
| # | Row | umn | Material | Fluid | Flow Rate | perature |
| 1 | 1 | 1 | ZSM-11 | H₂ | 2.5 cm³/min | 20° C. |
| 2 | 1 | 2 | ZSM-11 | H₂ | 2.5 cm³/min | 100° C. |
| 3 | 1 | 3 | ZSM-11 | H₂ | 2.5 cm³/min | 150° C. |
| 4 | 1 | 4 | ZSM-11 | H₂ | 2.5 cm³/min | 200° C. |
| 5 | 1 | 5 | ZSM-11 | H₂ | 2.5 cm³/min | 250° C. |
| 6 | 1 | 6 | ZSM-11 | H₂ | 2.5 cm³/min | 300° C. |
| 7 | 1 | 7 | ZSM-11 | H₂ | 2.5 cm³/min | 350° C. |
| 8 | 1 | 8 | ZSM-11 | H₂ | 2.5 cm³/min | 400° C. |
| 9 | 2 | 1 | ZSM-11 | H₂ | 5 cm³/min | 20° C. |
| 10 | 2 | 2 | ZSM-11 | H₂ | 5 cm³/min | 100° C. |
| 11 | 2 | 3 | ZSM-11 | H₂ | 5 cm³/min | 150° C. |
| 12 | 2 | 4 | ZSM-11 | H₂ | 5 cm³/min | 200° C. |
| 13 | 2 | 5 | ZSM-11 | H₂ | 5 cm³/min | 250° C. |
| 14 | 2 | 6 | ZSM-11 | H₂ | 5 cm³/min | 300° C. |
| 15 | 2 | 7 | ZSM-11 | H₂ | 5 cm³/min | 350° C. |
| 16 | 2 | 8 | ZSM-11 | H₂ | 5 cm³/min | 400° C. |
| 17 | 3 | 1 | ZSM-11 | H₂ | 10 cm³/min | 20° C. |
| 18 | 3 | 2 | ZSM-11 | H₂ | 10 cm³/min | 100° C. |
| 19 | 3 | 3 | ZSM-11 | H₂ | 10 cm³/min | 150° C. |
| 20 | 3 | 4 | ZSM-11 | H₂ | 10 cm³/min | 200° C. |
| 21 | 3 | 5 | ZSM-11 | H₂ | 10 cm³/min | 250° C. |
| 22 | 3 | 6 | ZSM-11 | H₂ | 10 cm³/min | 300° C. |
| 23 | 3 | 7 | ZSM-11 | H₂ | 10 cm³/min | 350° C. |
| 24 | 3 | 8 | ZSM-11 | H₂ | 10 cm³/min | 400° C. |
| 25 | 4 | 1 | ZSM-11 | H₂ | 15 cm³/min | 20° C. |
| 26 | 4 | 2 | ZSM-11 | H₂ | 15 cm³/min | 100° C. |
| 27 | 4 | 3 | ZSM-11 | H₂ | 15 cm³/min | 150° C. |
| 28 | 4 | 4 | ZSM-11 | H₂ | 15 cm³/min | 200° C. |
| 29 | 4 | 5 | ZSM-11 | H₂ | 15 cm³/min | 250° C. |
| 30 | 4 | 6 | ZSM-11 | H₂ | 15 cm³/min | 300° C. |
| 31 | 4 | 7 | ZSM-11 | H₂ | 15 cm³/min | 350° C. |
| 32 | 4 | 8 | ZSM-11 | H₂ | 15 cm³/min | 400° C. |
| 33 | 5 | 1 | ZSM-11 | H₂ | 20 cm³/min | 20° C. |
| 34 | 5 | 2 | ZSM-11 | H₂ | 20 cm³/min | 100° C. |
| 35 | 5 | 3 | ZSM-11 | H₂ | 20 cm³/min | 150° C. |
| 36 | 5 | 4 | ZSM-11 | H₂ | 20 cm³/min | 200° C. |
| 37 | 5 | 5 | ZSM-11 | H₂ | 20 cm³/min | 250° C. |
| 38 | 5 | 6 | ZSM-11 | H₂ | 20 cm³/min | 300° C. |
| 39 | 5 | 7 | ZSM-11 | H₂ | 20 cm³/min | 350° C. |
| 40 | 5 | 8 | ZSM-11 | H₂ | 20 cm³/min | 400° C. |
| 41 | 6 | 1 | ZSM-11 | H₂ | 25 cm³/min | 20° C. |
| 42 | 6 | 2 | ZSM-11 | H₂ | 25 cm³/min | 100° C. |
| 43 | 6 | 3 | ZSM-11 | H₂ | 25 cm³/min | 150° C. |
| 44 | 6 | 4 | ZSM-11 | H₂ | 25 cm³/min | 200° C. |
| 45 | 6 | 5 | ZSM-11 | H₂ | 25 cm³/min | 250° C. |
| 46 | 6 | 6 | ZSM-11 | H₂ | 25 cm³/min | 300° C. |
| 47 | 6 | 7 | ZSM-11 | H₂ | 25 cm³/min | 350° C. |
| 48 | 6 | 8 | ZSM-11 | H₂ | 25 cm³/min | 400° C. |

What is claimed is:

1. A heat treatment system, comprising:
(a) a plurality of feed lines for feeding a fluid;
(b) a plurality of treatment zones, each treatment zone being fed by one of the plurality of feed lines;
(c) wherein each treatment zone includes at least one chamber for holding a material and flowing the fluid through the material;
(d) a plurality of heating elements, wherein each heating element heats the material in one of the plurality of chambers; and
(e) a plurality of effluent conduits conducting fluid from the treatment zone, wherein each effluent conduit is equipped with a device selected from the group consisting of a sensing device, a detection device, a sampling device, or a combination thereof.

2. A heat treatment system according to claim 1, wherein there are six treatment zones.

3. A heat treatment system according to claim 1, wherein there are eight chambers for each treatment zone.

4. A heat treatment system according to claim 1, wherein each feed line further comprises a control valve for controlling flow rate of the fluid.

5. A heat treatment system according to claim 1, further comprising a diluent line for each feed line for feeding a diluent fluid to each feed line.

6. A heat treatment system according to claim 5, further comprising a mixing zone for mixing the diluent fluid from the diluent line with the fluid from the feed line.

7. A heat treatment system according to claim 1, further comprising a liquid line for each feed line for feeding a liquid to each feed line.

8. A heat treatment system according to claim 7, further comprising a means for mixing the liquid from the liquid line with the fluid from the feed line.

9. A heat treatment system according to claim 1 further comprising a common effluent line that communicates with all of the effluent conduits to collect all of the fluid from the effluent conduits, said common effluent line located downstream of the device.

10. A heat treatment system according to claim 1, further comprising a heated enclosure for heating the materials in the chambers, wherein the treatment zones are enclosed by the heated enclosure.

11. A method of treating fluid, comprising the steps of:
(a) feeding a fluid to at least one treatment zone, wherein the treatment zone includes a plurality of chambers, each chamber holding a treatment material;
(b) controlling flow rate of the fluid to the treatment zone;
(c) flowing the fluid through the material in each chamber;
(d) heating the material in each of the chambers independently of the other chambers;
(e) flowing the fluid out of the chambers; and
(f) determining a property of each of the fluids flowing out of the chambers.

12. A method according to claim 11, further comprising at least one step of diluting the fluid before feeding the fluid to the treatment zone, of mixing a liquid with the fluid before feeding the fluid to the treatment zone and of vaporizing the liquid before feeding the fluid to the treatment zone.

13. A method according to claim 11, further comprising the step of collecting the fluid flowing out of each chamber into a common line for each treatment zone and collecting the fluid from each treatment zone into a common conduit.

14. A method according to claim 11, further comprising the step of controlling the temperature in each chamber.

15. A method according to claim 11, wherein the feeding step includes feeding a plurality of fluids, further comprising the step of selecting one of the plurality of fluids and feeding the selected fluid to the treatment zone.

16. A method of treating fluid, comprising the steps of:
(a) feeding a fluid to a plurality of treatment zones, wherein each treatment zone includes at least one chamber, each chamber holding a treatment material;
(b) controlling flow rate of the fluid to each treatment zone;
(c) flowing the fluid through the material in each chamber;
(d) heating the material in each of the chambers independently of the other chambers;
(e) individually controlling temperature in each chamber;
(f) flowing the fluid out of the chambers; and
(g) determining a property of each of the fluids flowing out of the chambers.

17. A method according to claim 16, wherein the feeding step includes feeding a plurality of fluids, further comprising the step of selecting one of the plurality of fluids and feeding the selected fluid to the treatment zones.

18. A method according to claim 16, further comprising at least one step of diluting the fluid before feeding the fluid to the treatment zones, of mixing a liquid with the fluid before feeding the fluid to the treatment zones, and of vaporizing the liquid before feeding the fluid to the treatment zones.

19. A method according to claim 16, further comprising the step of collecting the fluid flowing out of each chamber into a common line for each treatment zone and collecting the fluid from each treatment zone into a common conduit.

20. A method of treating material, comprising the steps of:
(a) feeding a fluid to at least one treatment zone, wherein the treatment zone includes a plurality of chambers, each chamber holding a material to be treated;
(b) controlling flow rate of the fluid to the treatment zone;
(c) flowing the fluid through the material in each chamber;
(d) heating the material in each of the chambers independently of the other chambers;
(e) flowing the fluid out of the chambers; and
(f) monitoring each of the fluids flowing out of the chambers.

21. A method of treating material, comprising the steps of:
(a) feeding a fluid to a plurality of treatment zones, wherein each treatment zone includes at least one chamber, each chamber holding a material to be treated;
(b) controlling flow rate of the fluid to each treatment zone;
(c) flowing the fluid through the material in each chamber;
(d) heating the material in each of the chambers independently of the other chambers;
(e) individually controlling temperature in each chamber;
(f) flowing the fluid out of the chambers; and
(g) monitoring each of the fluids flowing out of the chambers.
